(19) United States
(12) Patent Application Publication
(10) Pub. No.: US 2008/0014957 A1
(43) Pub. Date: Jan. 17, 2008

(54) Neighbour cell measurement and reporting in a multiple radio access technologies (RAT) environment

(75) Inventor: Ivan Ore, Nummela (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/822,138

(22) Filed: Jul. 2, 2007

(30) Foreign Application Priority Data
Jun. 30, 2006 (FI) 20065467

(51) Int. Cl. H04Q 7/20

(52) U.S. Cl. 455/452.1

(57) ABSTRACT

According to embodiments of the invention, user equipment (UE) performs inter-radio access technology (RAT) neighbour cell measurements during an idle mode of the UE. The inter-RAT measurement results may be stored in an internal memory of the UE during the Idle mode. When the UE initiates a connection setup, an inter-RAT measurement report containing inter-RAT measurement results obtained during the idle mode is sent to the network at the connection setup. Consequently, the inter-RAT measurement information is immediately available for a network decision at the beginning of the connected mode. For example, an inter-RAT handover can be decided and performed without a delay, based on the inter-RAT measurements made in advance during the idle mode and reported at the connection setup.

### FIELD OF THE INVENTION

The invention relates to an interworking between different radio access technologies.

### BACKGROUND OF THE INVENTION

Beyond third generation (3G) wireless systems (B3G) and 4G mobile communication systems are considered to be heterogeneous networks with multiple of radio access technologies (RATs). Examples of such multi-RAT environment include an 3G/WLAN overlay network and a 3G/2G environment. To be able to change between the radio access technologies, an inter-RAT handover protocol is needed.

In ETSi 3^{rd} Generation Partnership Program (3GPP) networks, for example, user equipment (UE) may be in an idle mode or in a connected mode. During the idle mode, the UE is registered to the network and monitors a paging channel but there is no radio bearer established and a cell reselection is made by the UE based on measurements of received signal level/quality of serving/neighbouring cells and network information (e.g. network ID, network configuration, neighbouring cell list). During the connected mode, the UE is in an active communication state (there is an ongoing user service) and a radio access network (RAN) will decide on a handover. The handover is a network-controlled type of change of cell initiated by the network based on radio sub-system criteria (e.g. RF level, quality, distance) and possible network directed criteria (e.g. system load control). For handover, the UE assumes a fundamental role in delivering a number of measurements to the network to be used for handover decision. In addition to conventional intra-RAT measurements, such as measurements required for a handover within an UMTS radio access network (UTRAN), the UE measurements may include Inter-RAT measurements, i.e. measurements on downlink physical channels belonging to another radio access technology than UTRAN, e.g. GSM or WLAN. Reporting of inter-RAT cell measurements (e.g. GSM cells, 3G cells, non-3GPP nodes) is required from the UE and is needed as input to network decisions such as hand-over, load control, network optimisation etc. The network requires inter-RAT measurements for some action such as handover, or for redirecting the connection to another RAT, the network has to command to UE to start inter-RAT cell measurements in the connected mode, or if the UE is in an idle mode, after a connection setup, and then take network decision in the connected mode. These measurements delay the handover/switching process. Besides, the inter-RAT measurements in dedicated mode are done at expenses of inefficient data transmission or resource consumption. Therefore it is desirable to avoid inter-RAT measurements in dedicated mode as much as possible.

Another approach to reduce the delay on the network decision is to include as a requirement that the inter-RAT cell and serving cell has to be co-located cells in the same site and sharing the same antennas. In this way, there is no need of inter-RAT neighbor cell measurements and the handover is done blindly.

Scenarios regarding 3GPP system architecture are disclosed in the document: 3GPP TR 23.882 V1.2.3 (2006-06), 3rd Generation Partnership Project; Technical Specification Group Services and System Aspects; 3GPP System Architecture Evolution: Report on Technical Options and Conclusions (Release 7).

### BRIEF DESCRIPTION OF THE INVENTION

An object of the present invention is a new mechanism for inter-RAT measurements. The objects of the invention are achieved by an invention disclosed in the independent claims. The preferred embodiments of the invention are disclosed in the dependent claims.

According to embodiments of the invention, user equipment (UE) performs inter-radio access technology (RAT) neighbour cell measurements during an idle mode of the UE. The latest inter-RAT measurement results may be stored in an internal memory of the UE during the Idle mode. When the UE initiates a connection setup, an inter-RAT measurement report containing inter-RAT an appropriate number of measurement results obtained during the idle mode is sent to the network at the connection setup. Consequently, the inter-RAT measurement information is immediately available for a network decision at the beginning of the connected mode. For example, an inter-RAT handover can be decided and performed without a delay, based on the inter-RAT measurements made in advance during the idle mode and reported at the connection setup.

### BRIEF DESCRIPTION OF THE DRAWINGS

In the following the invention will be described in greater detail by means of example embodiments with reference to the attached drawings, in which

FIG. 1 illustrates examples of different radio access technologies and a simplified block diagram of user equipment according to an embodiment of the invention:

FIG. 2 is a diagram illustrating idle and connected modes of user equipment according an embodiment of the invention;

FIG. 3 is a signalling and flow diagram illustrating an inter-RAT measurement and reporting according to an embodiment of the invention;

FIG. 4 is a flow diagram illustrating operation of user equipment according an embodiment of the invention; and

FIG. 5 is a flow diagram illustrating operation of a network control unit according an embodiment of the invention.

### DESCRIPTION OF EXAMPLE EMBODIMENTS

Principles of the present invention can be applied to any types of radio access technologies (RATs) for enhancing inter-RAT interworking. Examples of radio access technologies include 3GPP radio access, UMTS radio access UTRAN (Wideband CDMA), GSM radio access, CDMA 2000 radio access, Wireless Local Area Networks (WLANs), such as IEEE 802.XX networks, Bluetooth. Generally, a radio access technology may refer to any 2G, 3G, 4G or higher generation mobile communication technology and their different versions, as well as to any other wireless radio access technology arranged to interwork with such a mobile communication technology.

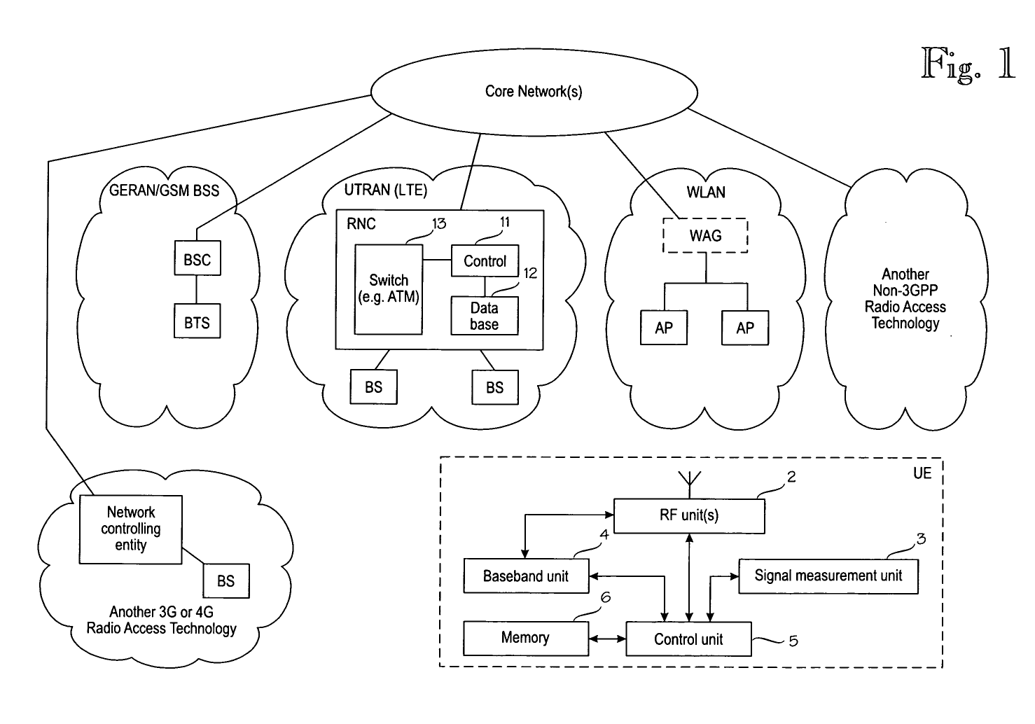

In the following, example handovers from 3GPP-type radio access technologies, such as 3G or 3.9G (also referred to as UTRAN LTE, Universal Terrestrial Radio Access Network Long Term Evolution, or Super 3G) or EUTRAN (3GPP proposal of an evolution of the 3G WCDMA system towards a B3G system), to other RATs are described but inter-RAT handovers according to embodiments of the invention can similarly be implemented between any pair of different RATs, including 4G mobile communications systems. Referring to FIG. 1, a radio access network (RAN) is the part of a mobile communication system that implements a radio access technology. Conceptually, the radio access network is situated between the mobile radio unit and the core network (CN), and can be found in any mobile communications system although it may be referred to with a different term depending on the wireless communications standard in question. The mobile radio unit is varyingly known as user equipment (UE), terminal equipment, mobile station, etc., depending on the wireless communications standard in question. Also the configuration and design of user equipment varies depending functions, services and radio access systems supported by the UE. Any user equipment UE contains one or more radio frequency (RF) units 2 (transmitter, receiver, transceiver) enabling the communication with the radio access technology or technologies supported by the UE. User equipment also contains a signal measuring unit 3 enabling measuring received downlink signal levels from the serving cell and one or more neighbour cells in one or more RATs. The UE may also contain a base-band processing unit 4 for processing baseband signals from and to the RF unit (s) 2. The operation of the UE and various elements thereof is controlled by a control unit 5 (such as a micro controller, microprocessor, or any other programmable device) having an associated memory 6 for storing data and software.

Examples of radio access network types include GSM BSS (base station subsystem), GERAN, UTRAN and EUTRAN. The GSM radio access network contains of Base Transceiver Stations (BTS) and Base Station Controllers (BSC), which are together referred to as a BSS. Its purpose is to manage the radio link between mobile phones and a telecommunication core network CN. This access network provides access to both Circuit Switched (CS) and Packet Switched (PS) core networks. GERAN, GSM/EDGE radio access network includes, in addition to the basic GSM, GPRS and EDGE technologies and can be connected to a UMTS core network, thus enabling real-time IP-based services. UTRAN, UMTS Terrestrial Radio Access Network, one of the 3rd Generation Wireless Mobile Communication Technologies, can carry many traffic types from real-time Circuit Switched to IP based Packet Switched. The UTRAN allows connectivity between the UE (user equipment) and the core network CN. UMTS may typically use wideband code division multiple access (WCDMA). The UTRAN contains the base stations BS, which are called Node Bs, and Radio Network Controllers (RNC). The RNC provides control functionalities for one or more Node Bs. A Node B and an RNC can be the same device, although typical implementations have a separate RNC located in a central office serving multiple Node B's. Despite the fact that they do not have to be physically separated, there is a logical interface between them. The RNC and its corresponding Node Bs are called the Radio Network Subsystem (RNS). There can be more than one RNS present in an UTRAN.

A radio access network (RAN) typically contain some type of network controlling/governing entity, such as a Radio Network Controller (RNC) in UTRAN or Base Station Controller (BSC) in GSM BSC, which is responsible for control of the base stations BS (e.g. Node-Bs) which are connected to the controller. As used herein, the term network controller or network controlling/governing entity refers to any network element or a set of network elements capable of using inter-RAT measurements for a network decision, Such element may also be a base station or a Node-B. The network controlling/governing entity may contain a controller 11 programmed to carry out radio resource management and mobility management functions, etc. The controller 12 may be associated with a memory or database 12 for maintaining information required in the management functions The network controlling/governing entity may include a switch unit 13 (such an Asynchronous Transfer Mode, ATM, switch) for switching connection between network elements within the RAN, The network controlling/governing entity may be connected to a Circuit Switched Core Network through e.g. Media Gateway MGW (not shown) and to e.g. a Serving GPRS Support Node SGSN in a Packet Switched Core Network.

The RAT may also be implemented as a Wireless Local Area Network (WLAN), such as IEEE 802.XX network. A WLAN distribution network may comprise a WLAN access gateway WAG through which the WLAN may be connected to a core network CN.

Single user equipment, a dual-mode or multimode equipment, may support multiple (two or more) radio access networks. For instance it is common today for mobile stations to support both GSM and UMTS radio access technologies. It is then possible to seamlessly transfer an ongoing call or communication between different radio access networks without the user noticing any disruption in service.

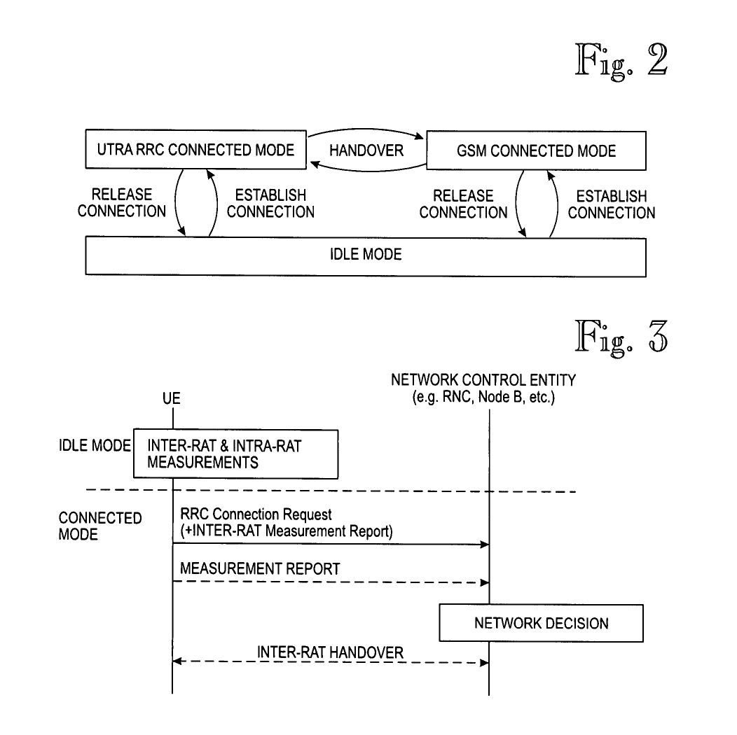

In typical radio access technologies, such as in 3GPP networks, user equipment or mobile station may assume different operating states or modes, namely an idle mode and a connected mode. The basic difference between these UE modes is that in the Idle mode, the UE has no connection or communication context established to the radio access network, but in the connected move, an RRC connection or similar communication context has been established between the UE and the radio access network. The UE is able to transit between the idle mode and the connected mode. It should be appreciated that there may further be different UE states between which the UE can transit in the connected mode. Also in the GSM, there exist an idle mode and a connected mode for CS (circuit switched) domain services and GSM/GPRS packet modes for PS (packet switched) domain services. Examples of these RRC states and state transitions are illustrated in FIG. 2.

During the idle mode, the UE may be registered to the network and monitoring a paging channel but no communication context (ongoing user service) exists and a cell reselection may be made by the UE based on measurements of received signal level/quality of serving/neighbouring cells and network/system information (e.g. network ID, network configuration, neighbouring cell list).

During the connected mode, the UE may be in an active communication state (there is an ongoing user service) and a radio access network (RAN) will decide on a handover. The handover is a network-controlled type of change of cell initiated by the network based on radio subsystem criteria (e.g. RF level, quality, distance) and possible network directed criteria (e.g. system load control). For handover, the UE assumes a fundamental role in delivering a number of measurements to the network to be used for handover decision. In addition to conventional intra-RAT measurements, such as measurements required for an Intra-RAT handover, e.g. within the UTRAN, the UE measurements may include Inter-RAT measurements, i.e. signal level or quality measurements on downlink physical channels belonging to another radio access technology (RAT) than UTRAN, e.g. GSM or WLAN. Reporting of inter-RAT cell measurements (e.g. GSM cells, 3G cells, non-3GPP nodes, WLAN access points) is required from the UE and is needed as input to network decisions, such as handover, load control, network optimisation, traffic sharing, load balancing, capacity increase etc. The inter-RAT measurements may also be used for optimising Inter-RAT neighbour cell lists, for providing location information. However, in existing 3GPP technologies, only intra-RAT neighbor cell measurements can be reported by UE during idle mode. If the network requires some action such as handover or redirects the connection to another RAT in existing 3GPP technologies, the network has to command to UE to start inter-RAT cell measurements after connection setup (during dedicated mode) and then take network decision dedicated mode. These measurements delay the handover/switching process. Besides, the inter-RAT measurements in dedicated mode are done at expenses of inefficient data transmission or resource consumption. Therefore it has been desirable to avoid inter-RAT measurements in dedicated mode as much as possible.

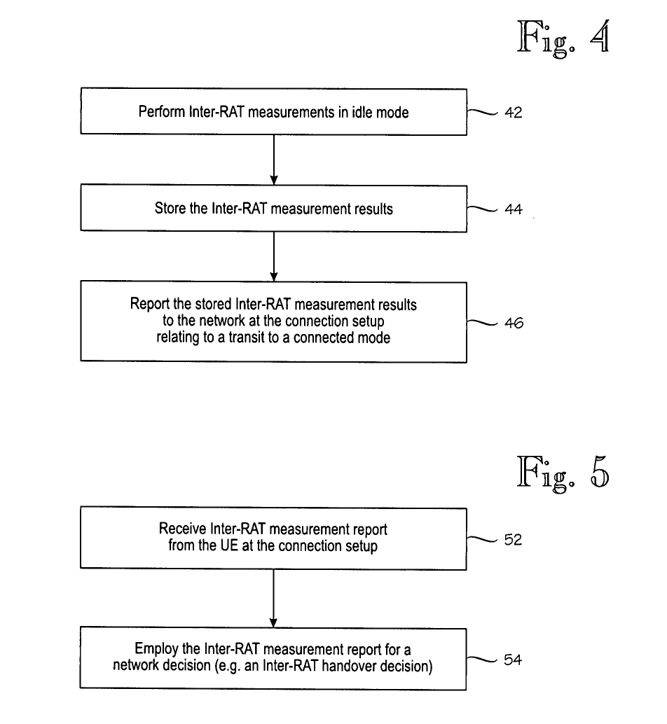

Referring now to FIGS. 3, 4 and 5, user equipment UE according to example embodiments of the invention performs Intra-RAT and inter-RAT neighbour cell measurements during an idle mode of the UE (step 42). For example, the UE in a 3GPP idle mode may measure a downlink 3GPP channel (an intra-RAT measurement) as well as physical downlink channels of neighbour cells of co-located other RATs, such as GSM, CDMA 2000, WLAN, etc (inter-RAT measurements). At least the latest inter-RAT and intra-RAT measurement results may be stored in an internal memory of the UE during the Idle mode (step 44). When the UE initiates a connection setup for transit to the connected mode, an inter-RAT measurement report is sent to the network at the connection setup (step 46). In order to limit the size of the message, there may be a maximum number of inter-RAT cells reported during connection setup. For example, UE in the 3GPP idle mode transits to the 3GPP connected mode and initiates an RRC connection setup by sending an RRC Connection Request to the 3GPP RAN. According to an embodiment of the invention, the inter-RAT measurement report containing inter-RAT measurement results obtained during the idle mode is incorporated into the RRC connection request, e.g. in one or more extension fields in the RRC Connection Request. Also an intra-RAT measurement report (e.g. 3GPP downlink channel measurement report) may be incorporated. The inter-RAT measurement report containing inter-RAT measurement results obtained during the idle mode may alternatively be sent in another RRC message at the RRC connection setup, e.g. in a measurement report message as indicated by a broken arrow in FIG. 3, or in any uplink control channel message, such as Cell Update, Initial Direct Transfer, URA (UTRAN Registration Area) Update, in the connected mode. Consequently, the inter-RAT measurement report is received (step 52) and immediately available for a network decision at the beginning of the connected mode (step 54). For example, an inter-RAT handover can be decided and performed without a delay based on the inter-RAT measurements made in advance during the idle mode and reported at the connection setup.

Intersystem handover or inter-RAT handover is used for handover from present RAT to another RAT, e.g. from 3GPP UTRAN (e.g. 3.9G) to GSM or CDMA2000. Typically, the term handover is used when services are switched in the circuit switched (CS) domain. A term inter-system cell reselection is also sometimes used for procedures switching an active connection from one RAT to another. As used herein, the handover refers to any inter-RAT switching of a connection in a connected mode of the UE.

Let us study an inter-RAT handover from UTRAN (e.g. LTE) or EUTRAN to another RAT, such as GSM BSS, as an example. The UE may receive the GSM neighbour cell information in the system information on a broadcast channel, for example. The UE performs the inter-RAT measurements in the idle state and reports them to the UTRAN as discussed above. The measurement report may contain, for example, a parameter RXLEV_Ncell(n), i.e. the GSM carrier RSSI value of the GSM neighbour cell(n). The RNC may apply a sliding averaging window to the RXLEV measurements. The averaged levels AVE_RXLEV_Ncell(n) are used as input to an inter-RAT handover decision algorithm.

As an example of an inter-RAT handover decision algorithm, the measurement results of the GSM neighbour cell may need to satisfy the following equation before the Inter-RAT handover from WCDMA to GPRS/GSM is possible:

AVE_RXLEV_NCell(n)>GSMncellRxLevMinHO(n)+Max(0,GSMncellTxPwrMaxTCH(n)−_max),

where
AVE_RXLEV _Ncell(n) is the averaged GSM carrier RSSI value of the GSM neighbour cell(n),
GSMncellRxLevMinHO(n) determines the minimum Required RSSI (dBm) level of the neighbouring cell(n), range −110 . . . −47 dBm, step 1 dBm, default −95 dBm
GSMncellTxPwrMaxTCH(n) indicated he maximum Tx power level (dBm) an UE may use in GSM neighbouring cell(n), range 0 . . . 43 dBm, step 1 dBm, default 33 dBm

If there are several neighbouring GSM cells which meet the hand-over criteria, the RNC may select the highest ranked GSM cell. The priority order may be controlled with ISHOPriorityCoverage defined for each GSM neighbour cell.

As another example of an inter-RAT handover decision criteria, a handover to a GSM cell may be initiated if the traffic load in the present UTRA cell is higher than a preset threshold load level, or based on other traffic load or network optimation criteria. Different kind of criteria may be used in any combination.

Thus, based on the measurement report from the UE, the RNC may make a handover decision and initiate resource reservation from the target GSM BSS. Upon receiving an acknowledgement and a GSM Handover Command from the GSM BSS, the RNC may send to the UE an Inter-System Handover Command message that may carry a piggybacked GSM Handover Command. At this point the GSM RR (Radio Resource management) protocol in the UE may take control and send a GSM Handover Access message to the GSM BSS. After successful completion of the handover procedure, GSM BSS may initiate resource release from UTRAN which may release the radio connection and remove all context information for the UE concerned.

Let us study an inter-RAT handover from another RAT, such as GSM BSS, to UTRAN or EUTRAN, as another example. The UE may receive the UTRAN neighbour cell information in the GSM system information on a broadcast channel, for example. The UE performs the inter-RAT measurements in the idle state and reports them to the GSM BSS as discussed above. Based on the measurement report from the UE, the GSM BSS (or typically BSC) may make a handover decision and initiate resource reservation from the target UTRAN RNC. Upon receiving an acknowledgement and a UMTS Hand-over to UTRAN Command from the UTRAN RNC, the BSC may send to the UE an Inter-System Handover Command message that may carry a piggy-backed UMTS Handover to UTRAN Command which contains all information required to setup connection to a UTRA cell. The UE may complete the procedure with a Handover to UTRAN Complete message to the RNC. After successful completion of the handover procedure, the RNC may initiate resource release from the GSM BSS.

As a further embodiment, let us study an inter-RAT handover from UTRAN or EUTRAN another RAT, such as GSM/GPRS, using a cell reselection procedure. Again, the UE may receive the GSM neighbour cell information in the system information on a broadcast channel, for example. The UE performs the inter-RAT measurements in the idle state and reports them to the UTRAN as discussed above. Based on the measurement report from the UE, the RNC may make a handover decision. However, in the embodiment of the invention, the inter-RAT handover of Packet switched (PS) services between UTRAN and GPRS is based on a network-initiated cell re-selection procedure, where RNC sends a CELL CHANGE command to the UE which registers to the cell indicated by the CELL CHANGE command. The connection in UTRAN is released.

The above handovers between UTRAN/EUTRAN and GERAN/GSM BSS may be referred to as handovers between 3GPP access systems because these access systems are defined in the 3GPP standardization. Other radio access systems may be referred to as non-3GPP access systems, including WLAN 3GPP IP access. 3GPP standardization does not presently define any handover to non-3GPP radio access system. As depicted in 3GPP TR 23.882 V1.2.3 (2006-06), this could be based on Mobile IP. Another approach is to send a cell change command from the RNC to the UE to initiate a association of the UE to a WLAN access point. However, it is not essential to embodiments of the present invention, which procedure may be used for hand-over to a non-3GPP RAT. Embodiments of the present invention in which a non-3GPP RAT is measured during the idle mode and the inter-RAT measurements are reported to the 3GPP RAT at the connection setup provide a 3GPP RAT with non-3GPP measurement information for any network decision and procedure without any measurement delay.

It will be obvious to a person skilled in the art that, as the technology advances, the inventive concept can be implemented in various ways. The invention and its embodiments are not limited to the examples described above but may vary within the scope of the claims.

1. A method, comprising
user equipment performs inter-RAT neighbour cell measurements during an idle mode of the user equipment in a radio network environment having neighbouring cells of different radio access technologies (RATs),
the user equipment reports the inter-RAT neighbour cell measurements made during the idle mode to a serving network at a connection setup.

2. A method according to claim 1, comprising
the user equipment reports selected ones of the inter-RAT measurements made during the idle mode to a serving network at the connection setup.

3. A method according to claim 1, comprising
the user equipment reports the measurements of the best inter-RAT neighbour cells during the connection setup.

4. A method according to claim 1, comprising
the user equipment further reports the measurements of a channel used in the connection setup.

5. A method according to claim 1, comprising
a network receives the inter-RAT measurement report at the connection setup,
the network employs the received inter-RAT measurement report for a network decision.

6. A method according to claim 5, wherein the network decision includes one or more of a handover decision, and/or another network management decision or control decision.

7. A method according to claim 1, wherein the user equipment sends the inter-RAT measurement report in a radio resource control (RRC) message.

8. A method according to claim 6, wherein the user equipment sends the inter-RAT measurement report in a radio resource control (RRC) connection request message.

9. User equipment, comprising
measuring unit performing inter-RAT neighbour cell measurements during an idle mode of the user equipment in a radio network environment having neighbouring cells of different radio access technologies (RATs),
a control unit reporting the inter-RAT neighbour cell measurements made during the idle mode to a serving network at a connection setup.

10. User equipment according to claim 9, comprising
the user equipment reports selected ones of the inter-RAT measurements made during the idle mode to a serving network at the connection setup.

11. User equipment according to claim 9, comprising
the user equipment reports the measurements of the best inter-RAT neighbour cells during the connection setup.

12. User equipment according to claim 9, comprising
the user equipment further reports the measurements of a channel used in the connection setup.

13. User equipment according to claim 9, wherein the user equipment sends the inter-RAT measurement report in a radio resource control (RRC) message.

14. User equipment according to claim 13, wherein the user equipment sends the inter-RAT measurement report in a radio resource control (RRC) connection request message.

15. A network control unit, comprising
a network control unit receives a inter-RAT measurement report from user equipment at the connection setup, said inter-RAT measurement report containing inter-RAT neighbour cell measurements made during the idle mode prior to the connection setup in a radio network environment having neighbouring cells of different radio access technologies (RATs),
the network control unit employs the received inter-RAT measurement report for a network decision.

16. A network control unit according to claim 15, wherein the network decision includes one or more of a handover decision, and/or another network management decision or control decision.

17. A network control unit according to claim 15, comprising
the user equipment reports selected ones of the inter-RAT measurements made during the idle mode to a serving network at the connection setup.

18. A network control unit according to claim 15, comprising
inter-RAT measurement report contains the measurements of the best inter-RAT neighbour cells during the connection setup.

19. A network control unit according to claim 15, comprising
inter-RAT measurement report contains the measurements of a channel used in the connection setup.

20. A network control unit according to claim 15, wherein the inter-RAT measurement report is part of a radio resource control (RRC) message.

21. A network control unit according to claim 20, wherein the the inter-RAT measurement report is part of a radio resource control (RRC) connection request message.

22. A network control method, comprising
user equipment performs inter-RAT neighbour cell measurements during an idle mode of the user equipment in a radio network environment having neighbouring cells of different radio access technologies (RATs),
the user equipment reports the inter-RAT neighbour cell measurements made during the idle mode to a serving network at a connection setup,
a network receives the inter-RAT measurement report at the connection setup,
the network employs the received inter-RAT measurement report for a network decision.

23. A radio access network, comprising
a network control unit configured to receive a inter-RAT measurement report from user equipment at the connection setup, said inter-RAT measurement report containing inter-RAT neighbour cell measurements made during the idle mode prior to the connection setup in a radio network environment having neighbouring cells of different radio access technologies (RATs),
the network control unit being further configured to employ the received inter-RAT measurement report for a network decision.
